(19) United States
(12) Patent Application Publication
(10) Pub. No.: US 2007/0212598 A1
(43) Pub. Date: Sep. 13, 2007

(54) Apparatus for controlling temperature of secondary battery, vehicle battery pack, and computer-readable medium storing program for controlling temperature of secondary battery

(75) Inventors: Takuma Iida, Kadoma-shi (JP); Masateru Tsutsumi, Toyohashi-shi (JP); Yasushi Matsukawa, Toyohashi-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Panasonic EV Energy Co., Ltd., Kosai-shi (JP)

(21) Appl. No.: 11/714,380

(22) Filed: Mar. 5, 2007

(30) Foreign Application Priority Data
Mar. 7, 2006 (JP) 2006-60683

(51) Int. Cl. H01M 10/50; G05D 23/00

(52) U.S. Cl. 429/62; 429/120; 165/287; 700/299

(57) ABSTRACT

A battery ECU reduces temperature variations and voltage variations, which would otherwise be caused at the time of heating of a secondary battery. The battery ECU activates a heater, to thus perform heating, when the temperature of the secondary battery is lower than a predetermined lower-limit temperature. The battery ECU calculates temperature variations ΔT or open circuit voltage variations ΔV achieved after heating operation, and compares the variations with a predetermined allowable threshold value. When the temperature variations ΔT or the voltage variations ΔV exceed a predetermined allowable threshold value, the battery ECU stops heating operation of the heater or commands so as to diminish the amount of heat to be generated, thereby attempting to render the temperature uniform.

### PRIORITY INFORMATION

This application claims priority to Japanese Patent Application No. 2006-60683 filed on Mar. 7, 2006, which is incorporated herein by reference in its entirety.

### BACKGROUND OF THE INVENTION

1. Field of the Invention

The present invention relates to control of the temperature of a secondary battery formed by stacking battery modules into layers.

2. Related Art

There has hitherto been put forward a technique for heating or warming a battery in order to prevent a decrease in the performance of the battery, which would otherwise arise at low temperature. For instance, proposed in Japanese Patent Laid-Open Publication No. 2001-314039 is a secondary battery input-and-output controller which charges, through use of regenerated energy, a battery mounted in a hybrid vehicle, thereby increasing the temperature of the battery. The battery at low temperature is heated by the heat of recharging reaction of the battery induced as a result of effecting charging/discharging control in such a way that a charged state (“State Of Charge”) of the battery enters a state where poor recharging efficiency is achieved.

Moreover, put forth in Japanese Patent Laid-Open Publication No. 2004-336832 is a temperature controller for detecting an SOC of a battery and the temperature of outside air and heating the battery during stoppage of driving operation of a vehicle by use of power from the battery when the SOC of the battery is greater than a predetermined SOC level and the temperature of outside air is lower than a predetermined temperature. The temperature controller prevents a drop in the temperature of the battery, which would otherwise arise after deactivation of the engine, to thus ensure the ease of activation of the engine.

The input-and-output controller described in Japanese Patent Laid-Open Publication No. 2001-314039 heats the battery by the heat of recharging action induced by the energy regenerated during travel. Accordingly, when the vehicle is stationary, the battery cannot be heated. Therefore, when the engine is inactive, there is a chance of the temperature of the battery being lowered by outside air, which may pose difficulty in cranking (starting the engine), which would otherwise be induced by the power discharged by the battery.

The battery temperature controller described in Japanese Patent Laid-Open Publication No. 2004-336832 detects an SOC of a battery and the temperature of outside air and heats the battery during stoppage of driving operation of a vehicle by use of power from the battery, and hence can ensure the ease of activation of the engine. However, the temperature controller suffers the following drawbacks. Specifically, in many cases, a secondary battery formed by stacking a plurality of single cells or formed by a plurality of battery modules, each of which is made by connecting a lot of single cells in series, is used for a battery to be mounted in a hybrid vehicle, or the like. When the secondary battery structured as mentioned above is heated, there may arise a case where temperature or voltage variations occur in the plurality of single cells or the plurality of battery modules, which constitute the secondary battery, because of heating characteristics of the heating section or the structure of the secondary battery. Since the single cells or the battery modules are connected in series within the secondary battery such that a desired high voltage is achieved, those variations may cause a drop-off in the performance of the secondary battery, and as well may accelerate deterioration of the secondary battery as a result of appearance of excessively-discharged single cells or battery modules because of a difference in discharging capability.

### SUMMARY OF THE INVENTION

Accordingly, the present invention prevents occurrence of variations in a secondary battery formed by combination of a plurality of battery modules, which would otherwise be caused when the secondary battery is heated, as well as preventing the secondary battery from entering an excessively-discharged state, or the like, to thus restrain deterioration of the secondary battery.

The present invention provides an apparatus for controlling a temperature of a secondary battery formed by combination of a plurality of battery modules, comprising:

a heating section;

a temperature measurement section for detecting the temperature of the secondary battery; and

a control section which causes the heating section to operate when the temperature detected by the temperature measurement section is lower than a lower-limit temperature and performs uniforming operation to suppress variations when variations in the temperature of the secondary battery achieved after heating operation of the heating section exceed an allowable value.

The present invention also provides an apparatus for controlling a temperature of a secondary battery formed by combination of a plurality of battery modules, comprising:

a heating section;

a temperature measurement section for detecting the temperature of the secondary battery;

a voltage measurement section for detecting an open circuit voltage of the secondary battery; and

a control section which causes the heating section to operate when the temperature detected by the temperature measurement section is lower than a lower-limit temperature and performs uniforming operation to suppress variations when variations in open circuit voltage of the secondary battery detected by the voltage measurement section after heating operation of the heating section exceed an allowable value.

The present invention also provides an apparatus for controlling a temperature of a secondary battery formed by combination of a plurality of battery modules, comprising:

a heating section;

a temperature measurement section for detecting the temperature of the secondary battery;

a voltage measurement section for detecting an open circuit voltage of the secondary battery; and

a control section which causes the heating section to operate when the temperature detected by the temperature measurement section is lower than a lower-limit temperature and which performs uniforming operation to reduce variations when an allowable value is exceeded by at least either temperature variations in the secondary battery detected by the temperature measurement section after heating operation or variations in open circuit voltage of the secondary battery detected by the voltage measurement section after heating operation of the heating section.

The present invention also provides a computer-readable medium storing a program for causing a computer to perform processing for controlling a temperature of a secondary battery formed by combination of a plurality of battery modules, the processing comprising:

inputting a temperature of the secondary battery output from a temperature measurement section or an open circuit voltage of the secondary battery output from a voltage measurement section;

comparing a predetermined lower-limit temperature stored in memory with the temperature;

outputting a heating command to a heating section when the temperature is determined to be lower than the lower-limit temperature;

calculating variations in the temperature of the secondary battery detected by the temperature measurement section after heating operation of the heating section or variations in the open circuit voltage of the secondary battery detected by the voltage measurement section;

comparing a predetermined allowable threshold value stored in the memory with the temperature variations or the open circuit voltage variations; and

performing predetermined uniforming operation for reducing the variations when at least either the temperature variations or the open circuit voltage variations are determined to have exceeded the predetermined allowable threshold value.

According to the present invention, when variations have arisen in the temperature or open circuit voltage of a secondary battery because of heating operation of the heating section, there is performed uniforming operation for suppressing such variations, thereby preventing early deterioration of the secondary battery.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail based on the following figures, wherein:

FIG. 1 is a block diagram of the entirety of a hybrid vehicle of the present invention;

FIG. 2 is a view showing a functional block for describing the configuration of a battery ECU (Electronic Control Unit) employed when a control section performs uniforming operation;

FIG. 3 is a flowchart of processing of the control section;

FIG. 4 is a detailed flowchart of uniforming operation;

FIG. 5 is another detailed flowchart of uniforming operation;

FIG. 6 is another flowchart of processing of the control section; and

FIG. 7 is yet another flowchart of processing of the control section.

### DETAILED DESCRIPTION OF THE PREFERRED EMBODIMENT

An embodiment of the present invention will be described hereinbelow by reference to the drawings.

The present embodiment describes, by way of an example, a case where a secondary battery formed by combination of a plurality of battery modules, each of which is formed by connecting multiple single cells in series, is used as a power source of a drive motor mounted in a hybrid vehicle. The present embodiment can also be applied to another apparatus. The battery module described herein also includes a battery made up of a single cell.

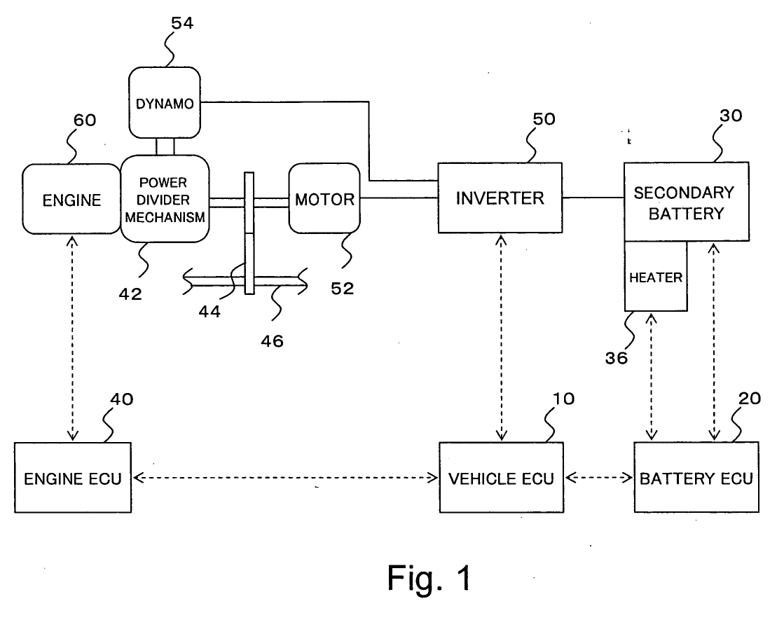

FIG. 1 shows the general configuration of a hybrid vehicle. A vehicle ECU 10 controls an inverter 50 and an engine ECU (electronic control unit) 40. The engine ECU 40 controls an engine 60. Moreover, a battery ECU 20 is supplied with detection signals of a voltage V, a temperature T, a current I, and the like, from a secondary battery 30; estimates an SOC of the secondary battery 30 from the detection signals; and transmits to the vehicle ECU 10 the thus-estimated SOC and the voltage V, the temperature T, and the like. The battery ECU 20 also controls a heater (a heating section) 36 which will be described later.

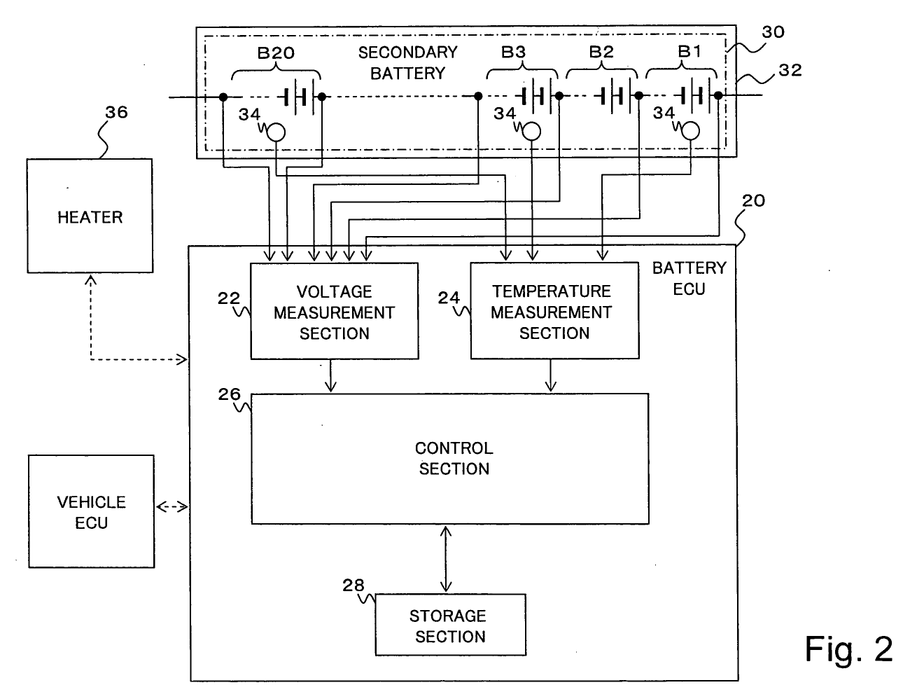

As shown in FIG. 2, the secondary battery 30 is configured by means of connecting battery blocks B1 to B20 in series. These battery blocks B1 to B20 are housed in a battery case 32. Each of the battery blocks B1 to B20 is formed by means of electrically connecting two battery modules together in series. Moreover, each of the battery modules is formed by electrically connecting six single cells in series. A nickel-metal hydride battery, a lithium ion battery, or the like, can be used as the single cell. No specific limitations are imposed on the number of battery blocks, the number of battery modules, and the number of single cells. Also, the configuration of the secondary battery 30 is not limited to the above-described example.

Moreover, a plurality of temperature sensors 34 are provided within the battery case 32. The plurality of temperature sensors 34 are arranged by means of taking a plurality of battery blocks whose temperatures are relatively close to each other as one group or taking a single battery block whose temperature comparatively differs from the temperatures of the other battery blocks as a single group; and placing a single temperature sensor 34 for each group. The battery blocks are grouped by measuring the temperature of each of the battery blocks through a preliminary experiment or the like. In the present embodiment, M (M is an integer) temperature sensors 34 are assumed to be provided. In a case where there is no necessity for distinguishing temperatures T(1) to T(M) measured by the respective temperature sensors 34, the temperature is expressed as T.

Turning back to FIG. 1, the heater 36 heats the respective battery modules constituting the secondary battery 30 upon receipt of a command from the battery ECU 20. The heater 36 has, e.g., a heating element disposed so as to contact a bottom surface of the battery module, and causes the heating element to heat the secondary battery 30 with the amount of heat instructed by the battery ECU 20. For instance, a plane heating element having a PTC (Positive Temperature Coefficient) characteristic is used for this heating element. Moreover, the heating element may also be heated by means of an IH (Induction Heating) system. For instance, hot air heated by an air conditioner equipped in a hybrid vehicle may also be used as the heat source used for heating the heating element. In this case, the heater 36 has a fan for guiding hot air around the heating element and a fan drive motor, and the heating element is placed at an inlet or outlet port of the fan. The heater 36 may be supplied with power from the secondary battery 30 or from a low-voltage battery which supplies power to accessories such as various ECUs or lights. Moreover, the heater 36 may also be supplied with power from an external power source, such as a commercial power source or the like. When the external power source is utilized, the user connects the external power source to the heater 36 by means of a cable or the like, in order to heat the secondary battery 30. When the external power source is utilized, the heater 36 itself controls the amount of heat. In short, the heater 36 has a control section 26 which will be described later.

The secondary battery 30 supplies power to a motor 52 via a relay unit (not shown) and the inverter 50. During discharge of the secondary battery 30, the inverter 50 converts the d.c. power supplied from the secondary battery 30 into a.c. power, and supplies the motor 52 with the a.c. power. During charge of the secondary battery 30, the inverter 50 converts the a.c. power supplied from a dynamo 54 into d.c. power, and supplies the secondary battery 30 with the d.c. power.

The engine 60 transmits power to wheels via a power divider mechanism 42, a reduction gear 44, and a drive shaft 46. The motor 52 transmits power to the wheels via the reduction gear 44 and the drive shaft 46. When the secondary battery 30 needs to be charged, a portion of power of the engine 60 is supplied to the dynamo 54 via the power divider mechanism 42 and utilized for recharging.

The vehicle ECU 10 outputs a control command to the engine ECU 40 and the inverter 50 in accordance with information about the driving state of the engine 60 from the engine ECU 40, the amount of actuation of a gas pedal, the amount of actuation of a brake pedal, a shift range set by a shift lever, an SOC from the battery ECU 20, or the like, thereby driving the engine 60 and the motor 52.

As mentioned above, the battery ECU 20 outputs a heating command to the heater 36 so as to heat the secondary battery 30 with a desired amount of heat. More specifically, the battery ECU 20 is supplied with inputs of the temperatures T1 to Tm of the battery from the temperature sensors 34. When the temperatures are lower than a reference lower-limit temperature required for the secondary battery 30 to exhibit desired recharging-and-discharging capability, the battery ECU 20 outputs a command for effecting heating operation with a previously-set amount of heat.

The heater 36 heats the secondary battery 30 in order to prevent failure of the secondary battery 30 to exhibit desired charging/discharging capability, which would otherwise arise when the secondary battery 30 is charged or discharged before the temperatures T1 to Tm reach the reference lower-limit temperature, or to prevent occurrence of early deterioration of the secondary battery 30. Particularly, the heater 36 heats the secondary battery 30 in order to prevent an arbitrary battery module of the plurality of battery modules constituting the secondary battery 30 from entering an excessively-discharged state. To this end, the battery ECU 20 determines whether or not the heater 36 must heat the secondary battery 30, in accordance with the temperatures T1 to Tm before the vehicle ECU 10 commences predetermined startup processing upon receipt of a command for starting the engine serving as a drive source, or the like. When the result of the determination shows that heating is required, the vehicle ECU 10 is caused to suspend startup processing until the temperature of the secondary battery 30 reaches a desired lower-limit temperature or more. Moreover, the battery ECU 20 determines whether or not the heater 36 must heat the secondary battery 30, in accordance with the temperatures T1 to Tm, before the vehicle ECU 10 commences predetermined deactivation processing upon receipt of a command for deactivating the engine, or the like, so that start-up processing can be performed immediately as in a case where start-up processing is immediately performed when the engine, or the like, is re-started after elapse of a short period of time after deactivation of the engine. When the result of the determination shows that heating is required, the battery ECU 20 suspends deactivation processing until the temperature of the secondary battery 30 reaches a lower-limit temperature or more.

As mentioned above, early deterioration of the secondary battery 30 can be prevented by means of heating the secondary battery 30. Meanwhile, as a result of the heater 36 heating the secondary battery 30, there may arise a case where a temperature or voltage difference arises in the battery modules constituting the secondary battery 30. Accordingly, in the present embodiment, after having instructed the heater 36 to heat the secondary battery 30, the battery ECU 20 acquires the temperatures T1 to Tm and voltages V1 to Vn of the secondary battery 30 from the temperature sensor 34, thereby monitoring the temperature and voltage variations. When the variations have exceeded allowable values, heating is interrupted, and uniforming operation for reducing the variations is performed.

Next, the configuration of the battery ECU 20 of the present embodiment will be further described by reference to FIG. 2. FIG. 2 is a view showing a functional block used for describing the configuration of the battery ECU 20 of the present embodiment.

A voltage measurement section 22 measures a voltage appearing at a terminal of the secondary battery 30. In the present embodiment, the voltage measurement section 22 measures terminal voltages V(1) to V(20) of the battery blocks B1 to B20. The voltage measurement section 22 generates voltage data used for specifying the terminal voltages V(1) to V(20), and outputs the thus-generated voltage data to the control section 26. The voltage measurement section 22 outputs voltage data to the control section 26 at a preset frequency, and the control section 26 stores the voltage data into a storage section 28. When the terminal voltages V(1) to V(20) measured by the voltage measurement section 22 do not particularly need to be distinguished from each other, the voltages are generically expressed as a voltage V. The voltage V measured by the voltage measurement section 22 is an open circuit voltage (OCV), which is a terminal voltage achieved when no load is connected to the battery blocks.

A temperature measurement section 24 measures the temperature of the secondary battery 30. In the embodiment, the temperature measurement section converts into digital signals the analogue signals output from the respective temperature sensors 34 set for the respective groups; generates temperature data used for specifying the temperature of a battery for each group from the digital signals; and outputs the thus-generated temperature data to the control section 26. The temperature measurement section 24 also outputs the temperature data to the control section 26 at a preset frequency, as well. The control section 26 stores the temperature data into the storage section 28.

When the temperature detected by the temperature measurement section 24 is found to be lower than the lower-limit temperature by reference to the temperature data stored in the storage section 28, the control section 26 activates the heater 36. When variations in the temperature of the secondary battery 30 achieved after heating operation of the heater 36 exceed an allowable value, the control section 26 performs uniforming operation for reducing the variations.

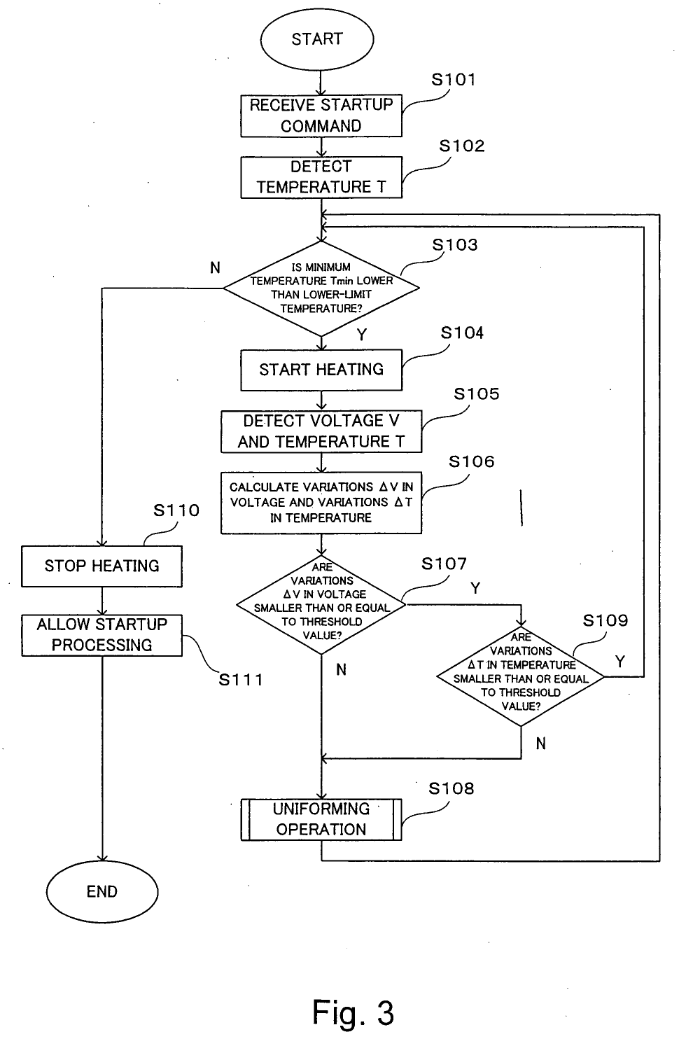

FIG. 3 shows a flowchart of processing of the control section 26. This processing is for a case where in the stationary state of the vehicle the user (driver) attempts to start driving of a vehicle by means of actuation of an ignition key.

First, upon receipt of the startup command output as a result of the user having activated an ignition switch via the vehicle ECU 10 (S101), the control section 26 acquires temperatures T(1) to T(M) from the storage section 28 as the temperature of the secondary battery 30 (S102). A comparison is made as to whether or not the lowest temperature Tmin among detected temperatures T(1) to T(M) is lower than the lower-limit temperature, and a determination is then made as to whether or not the lowest temperature Tmin of the secondary battery 30 is lower than the lower-limit temperature (S103). When the lowest temperature Tmin of the secondary battery 30 is higher than the lower-limit temperature, there is no risk of occurrence of excessive discharge even if the secondary battery 30 is subjected, in an unchanged state, to discharge control. Hence, the control section 26 allows the vehicle ECU 10 to perform startup processing of the engine (S111). Since heat control is not performed, heating stop processing is skipped.

Meanwhile, when the lowest temperature Tmin of the secondary battery 30 is lower than the lower-limit temperature, the control section 26 outputs a heating command to the heater 36, thereby initiating heating of the secondary battery 30 (S104) After initiation of heating operation, the control section 26 again acquires temperatures T(1) to T(M) and the voltages V(1) to V(20) from the storage section 28 (S105), and calculates a voltage variation ΔV and a temperature variation ΔT (S106). Specifically, ΔT is calculated as a difference between the highest temperature Tmax and the lowest temperature Tmin among the temperatures T(1) to T(M) acquired in S105, and ΔV is calculated as a difference between the maximum voltage Vmax and the minimum voltage Vmin among the voltages V(1) to V(20) acquired in S105. After calculation of the voltage variation and the temperature variation, these variations are compared with corresponding predetermined allowable values. First, a determination is made as to whether or not the voltage variation ΔV is lower than or equal to an allowable threshold value (S107). When the voltage variation ΔV is lower than or equal to the allowable threshold value, no problem arises in a voltage, and hence a determination is then made as to whether or not the temperature variation ΔT is lower than or equal to the allowable threshold value (S109). When the temperature variation ΔT is also lower than or equal to the allowable threshold value, no problem is determined to be present in terms of a voltage and a temperature. Heating operation of the heater 36 is continually performed, and processing subsequent to S103 is iterated. Specifically, a determination is again made as to whether or not the temperature of the secondary battery 30 is lower than the lower-limit temperature. When the temperature is lower than the lower-limit temperature, heating is continually performed (“initiation of heating” means continuation of heating). When the temperature has become equal to or higher than the lower-limit temperature, heating is stopped (S110). Start-up processing of the vehicle ECU 10 is allowed (S111).

When the voltage variation ΔV exceeds an allowable threshold value or when the voltage variation ΔV is lower than the allowable threshold value but the temperature variation ΔT exceeds the allowable threshold value, continuation of heating is not appropriate. Accordingly, processing proceeds to predetermined uniforming operation (S108). The uniforming operation is for reducing the voltage variation ΔV or the temperature variation ΔT, to thus essentially uniform the voltage or temperature. After performance of uniforming operation, processing subsequent to S103 is again iterated. Specifically, a determination is made as to whether or not the temperature of the secondary battery 30 is lower than the lower-limit temperature. When the temperature is equal to or higher than the lower-limit temperature, heating is stopped (S110), and the vehicle ECU 10 is allowed to perform start-up processing (S111). When heating remains stopped by means of uniforming operation, it goes without saying that there is no necessity for again stopping heating operation.

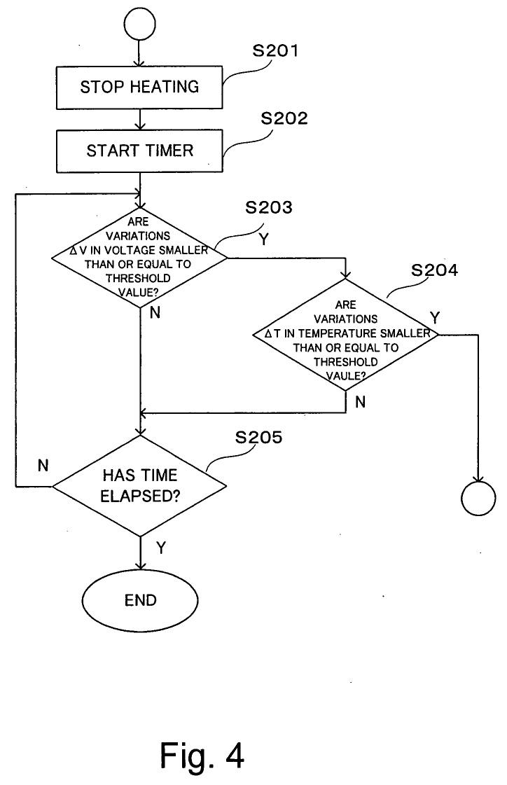

FIG. 4 shows a flowchart of uniforming operation shown in FIG. 3. In uniforming operation, when the voltage variation ΔV or the temperature variation ΔT exceeds a corresponding allowable threshold value, the control section 26 first outputs a heating stop command to the heater 36 in order to reduce a further increase in variation, which would otherwise be caused by heating, thereby stopping heating (S201). Next, a built-in timer is started (S202), and a determination is made as to whether or not the voltage variation ΔV and the temperature variation ΔT have become equal to or lower than the corresponding allowable threshold values by virtue of natural convection or diffusion resulting from stoppage of heating (S203, S204). Specifically, a determination is made as to whether or not the voltage variation ΔV is equal to or lower than the allowable threshold value (S203). When the variation ΔV is equal to or lower than the allowable threshold value, a determination is then made as to whether or not the temperature variation ΔT is equal to or lower than the allowable threshold value (S204). When both of the voltage variation ΔV and the temperature variation ΔT have become equal to or lower than the corresponding allowable threshold values, the uniforming operation is stopped, as uniforming is considered to have been completed. In this case, processing subsequent to S103 is performed as shown in FIG. 3. Specifically, heating and uniforming operations are iterated until the temperature of the secondary battery 30 becomes equal to or lower than the lower-limit temperature.

Meanwhile, when either or both the voltage variation ΔV and the temperature variation ΔT exceed the corresponding allowable threshold values, a determination is made as to whether or not a predetermined time has elapsed (S205). When the predetermined time has not yet elapsed; namely, when uniforming operation has not yet been performed for a predetermined period, processing subsequent to S203 is again repeated, thereby attempting to achieve a uniform state by means of natural convection resulting from stoppage of heating operation. When a uniform state has not been achieved within a predetermined period of time through uniforming operation as a result of stoppage of heating; namely, when at least one of the voltage variation ΔV and the temperature variation ΔT still remains in excess of the corresponding allowable threshold value, processing is aborted, as an anomaly is considered to have arisen (error processing).

As mentioned above, even when the voltage variation ΔV or the temperature variation ΔT has arisen during heating operation of the heater 36, the variations are reduced by means of uniforming operation; namely, stoppage of heating, thereby preventing deterioration of the secondary battery 30.

In processing shown in FIGS. 3 and 4, a predetermined period of time is set for uniforming operation. However, a given period of time can also be set for heating operation itself. The reason for this is that there is assumed a case where the temperature of the secondary battery 30 does not rise to the lower-limit temperature or higher because of an anomaly in the heater 36, no matter how long heating is continued. In this case, a timer is started after heating has been initiated in, e.g., S104, in the flowchart shown in FIG. 3. When the temperature of the secondary battery 30 does not rise to the lower-limit temperature or higher after elapse of a predetermined time, the essential requirement is to abort heating, thereby completing operation.

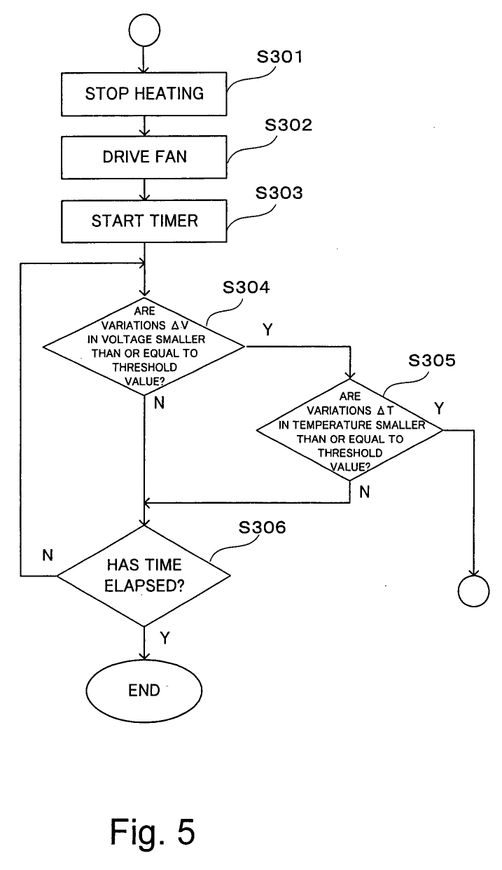

FIG. 5 shows another flowchart of uniforming operation shown in FIG. 3. In FIG. 4, an attempt has been made to achieve a uniform state by means of stopping heating operation of the heater 36. However, this is a case where an attempt is made to achieve uniform state through forced convection by means of additionally driving a fan.

When the voltage variation ΔV or the temperature variation ΔT exceeds a corresponding allowable threshold value, the control section 26 first outputs a heating stop command to the heater 36 in order to reduce a further increase in variation, which would otherwise be caused by heating, thereby stopping heating (S301). Next, the fan is driven to thus cause the secondary battery 30 to induce forced convection (S302). When the heater 36 is built of a heating element and a fan, the essential requirement is to stop heating by the heating element in S301 and to continue driving of the fan. Next, the built-in timer is started (S303), and a determination is made as to whether or not the voltage variation ΔV and the temperature variation ΔT have become equal to or lower than the corresponding allowable threshold values by virtue of stopping of the heating operation and forced convection induced by the fan (S304, S305). Specifically, a determination is made as to whether or not the voltage variation ΔV is equal to or lower than the allowable threshold value (S304). When the variation ΔV is equal to or lower than the allowable threshold value, a determination is then made as to whether or not the temperature variation ΔT is equal to or lower than the allowable threshold value (S305). When both of the voltage variation ΔV and the temperature variation ΔT have become equal to or lower than the corresponding allowable threshold values, the uniforming operation is stopped, as uniforming is considered to have been completed. Subsequently, driving of the fan is stopped, and processing subsequent to S103 is performed as shown in FIG. 3.

Meanwhile, when either or both of the voltage variation ΔV and the temperature variation ΔT exceed the corresponding allowable threshold values, a determination is made whether or not a given time has elapsed (S306). When the given time has not yet elapsed; namely, when uniforming operation has not yet been performed for a predetermined period, processing subsequent to S304 is again repeated, thereby attempting to achieve a uniform state by means of stoppage of heating operation and forced convection performed by the fan. When a uniform state has not been achieved within a predetermined period of time through stoppage of heating operation acting as uniforming operation and forced convection induced by the fan; namely, when at least one of the voltage variation ΔV and the temperature variation ΔT still remains in excess of the corresponding allowable threshold value, processing is aborted, as an anomaly is considered to have arisen (error processing).

Processing shown in FIGS. 3 to 5 is achieved by means of sequentially reading a control program stored in ROM of the battery ECU 20. As in the case of a general-purpose computer, the battery ECU 20 has a processor, memory devices, such as ROM or RAM, an input/output interface, and a data bus. Data pertaining to the temperature and voltage of the secondary battery 30 are input by way of the input/output interface. The lower-limit temperature and the allowable threshold values (the allowable threshold value for the temperature variation ΔT and the allowable threshold value for the voltage variation ΔV) are previously stored in the memory. The processor calculates the temperature variation ΔT from input temperature data, as well as calculating the voltage variation ΔV from input voltage data. The thus-calculated variations ΔT and ΔV are compared with the corresponding allowable threshold values read from the memory. The processor performs uniforming operation in accordance with the result of comparison, or outputs a heating stop instruction (command) to the heater 36, thereby stopping heating operation. The battery ECU 20 does not output a heating command or a heating stop command directly to the heater 36 but may output the command to the vehicle ECU 10, and the vehicle ECU 10 may output the command to the heater 36. In this case, the vehicle ECU 10 and the battery ECU 20 function as a computer for controlling operation of the heater 36.

The embodiments of the present invention have been described above. However, the present invention is not limited to the embodiments, and other embodiments are also feasible.

For instance, in uniforming operation in FIG. 4 or 5, heating operation of the heater 36 is stopped. However, control may also be performed in such a way that the amount of heat generated by the heater 36 is diminished. Specifically, the control section 26 outputs a heating command to the heater 36 in such a way that the amount of heat generated by the heating element is changed from a first amount of heat, to a second amount of heat which is smaller than the first amount of heat. Alternatively, a decrease in the amount of heat to be generated and driving of the fan may also be combined together. For instance, the period of uniforming operation is divided into three stages. In a first period, the amount of heat to be generated is diminished. In a second period, heating operation is stopped. In a third period, stoppage of the heating operation and driving of the fan are performed in combination. The fan may also be driven while the amount of heat to be generated is maintained, or the fan may also be driven with a reduction in the amount of heat to be generated. A determination may also be made as to whether or not driving of the fan is required, from a relationship between a location where variations have arisen and a position where the fan is set. Any of these may also be performed according to the magnitude of the voltage or temperature variation. For instance, when variations are considerably large, stoppage of heating operation and driving of the fan are used in combination. However, when variations exceed a corresponding allowable threshold value but are relatively small, the amount of heat to be generated is decreased, or the like.

In the present embodiment, a determination is made, from the voltage variation ΔV and the temperature variation ΔT, as to whether or not uniforming operation is performed. However, a determination may also be made by use of only the voltage variation ΔV or the temperature variation ΔT.

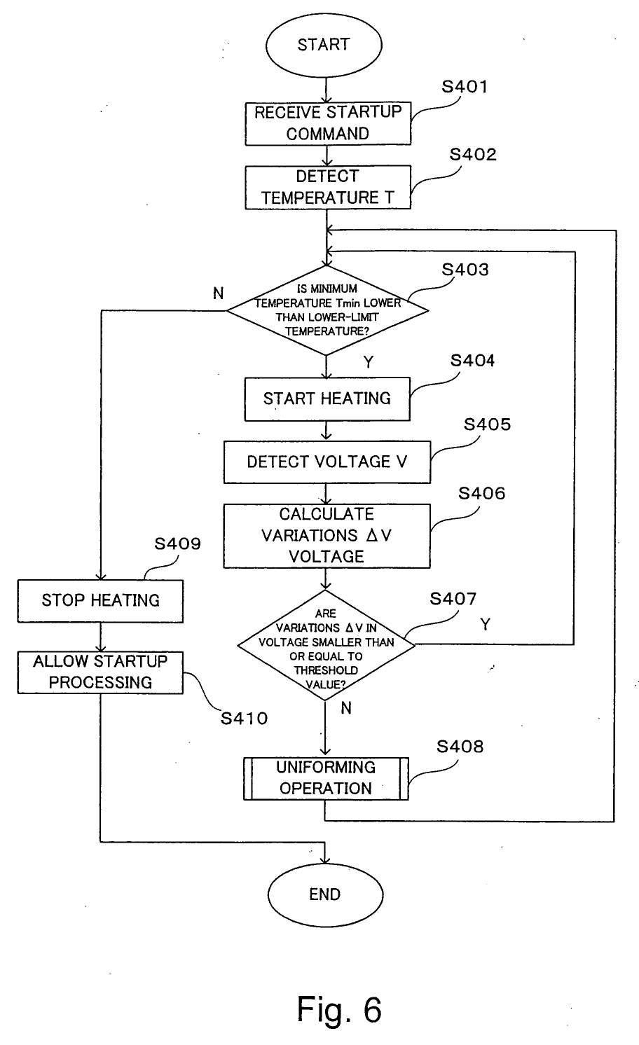

FIG. 6 shows a processing flowchart employed when uniforming operation is performed by use of the voltage variation AV. First, upon receipt of the startup command output as a result of the user having activated the ignition switch via the vehicle ECU 10 (S401), the control section 26 acquires temperatures T(1) to T(M) from the storage section 28 as the temperature of the secondary battery 30 (S402). The lowest temperature Tmin among detected temperatures T(1) to T(M) is compared with the lower-limit temperature, thereby rendering a determination as to whether or not the lowest temperature Tmin of the secondary battery 30 is lower than or equal to the lower-limit temperature (S403). When the lowest temperature Tmin of the secondary battery 30 is equal to or higher than the lower-limit temperature, there is no risk of the secondary battery being excessively discharged even if the secondary battery 30 is subjected, in this state, to discharge control. Hence, the control section 26 allows the vehicle ECU 10 to perform startup processing of the engine (S410).

In contrast, when the lowest temperature Tmin of the secondary battery 30 is lower than the lower-limit temperature, the control section 26 outputs a heating command to the heater 36, thereby initiating heating of the secondary battery 30 (S404) After initiation of heating operation, the control section 26 acquires voltages V1 to Vn from the storage section 28 (S405), and calculates the voltage variation ΔV (S406). Specifically, ΔV is calculated as a difference between the maximum voltage Vmax and the minimum voltage Vmin among the voltages V1 to Vn acquired in S405. After calculation of the voltage variation, a determination is made as to whether or not the voltage variation ΔV is lower than or equal to an allowable threshold value (S407). When the voltage variation ΔV is lower than or equal to the allowable threshold value, heating operation of the heater 36 is continued, and processing subsequent to S403 is iterated. Specifically, a determination is again made as to whether or not the temperature of the secondary battery 30 is lower than the lower-limit temperature. When the temperature is lower than the lower-limit temperature, heating is continually performed (“initiation of heating” means continuation of heating). When the temperature has become equal to or higher than the lower-limit temperature, heating is stopped (S409) Start-up processing of the vehicle ECU 10 is allowed (S410).

When the voltage variation ΔV exceeds an allowable threshold value, continuation of heating in the manner in which it is currently being performed is not appropriate, and hence processing proceeds to predetermined uniforming operation (S408). After performance of uniforming operation, processing subsequent to S403 is again iterated. Specifically, a determination is made as to whether or not the temperature of the secondary battery 30 is lower than the lower-limit value. When the temperature has risen in excess of the lower-limit temperature, heating is stopped (S409), and start-up processing of the vehicle ECU 10 is allowed (S410).

When uniforming operation is performed by use of the temperature variation ΔT, the essential requirement is to again acquire the temperature T [i.e., T(1) to T(M)] in S405 and to calculate the temperature variation ΔT in S406.

A weight or priority may be set between the voltage variation ΔV and the temperature variation ΔT. For instance, when the voltage variation is prioritized over the temperature variation, settings are effected such that the allowable threshold value for the voltage variation is made sufficiently smaller than the allowable threshold value for the temperature variation. Even when the temperature variation ΔT exceeds the allowable threshold value, heating operation of the heater 36 is continued without performance of uniforming operation in the case of the voltage variation ΔV being lower than or equal to the allowable threshold value, thereby enabling an early shift to start-up processing.

Moreover, in the present embodiment, when the temperature of the secondary battery 30 is lower than the lower-limit temperature, the secondary battery is heated with the heater 36 so as to rise in temperature to the lower-limit value or higher, to thus enable start-up processing; namely, the secondary battery 30 is heated to thus enable cranking. However, the program may be configured so as to prevent excessive heating of the secondary battery 30.

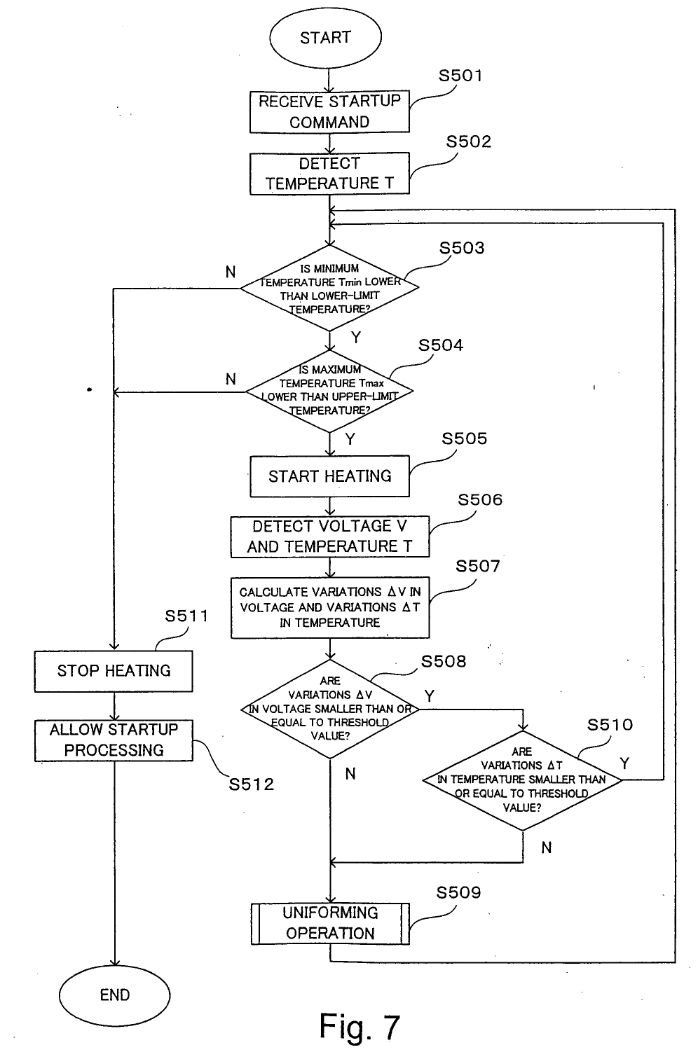

FIG. 7 shows a processing flowchart of the control section 26 achieved in this case. The flowchart differs from that shown in FIG. 3 in that it additionally includes determination processing for comparing the highest temperature Tmax among the temperatures T(1) to T(M) of the secondary battery 30 with a predetermined upper-limit temperature (S504).

First, upon receipt of the startup command output as a result of the user having activated the ignition switch via the vehicle ECU 10 (S501), the control section 26 acquires temperatures T(1) to T(M) from the storage section 28 as the temperature of the secondary battery 30 (S502). The lowest temperature Tmin among detected temperatures T(1) to T(M) is compared with the lower-limit temperature, thereby rendering a determination as to whether or not the lowest temperature Tmin of the secondary battery 30 is lower than or equal to the lower-limit temperature (S503). When the lowest temperature Tmin of the secondary battery 30 is equal to or higher than the lower-limit temperature, there is no risk of the secondary battery being excessively discharged even if the secondary battery 30 is subjected, in this state, to discharge control. Hence, the control section 26 allows the vehicle ECU 10 to perform startup processing of the engine (S512).

In contrast, when the lowest temperature Tmin of the secondary battery 30 is lower than the lower-limit temperature, a determination is made as to whether or not the maximum temperature Tmax of the temperatures T(1) to T(M) of the secondary battery 30 is lower than the upper-limit temperature (S504). When the maximum temperature Tmax is greater than the upper-limit temperature, heating is not appropriate, and hence start-up processing of the vehicle ECU 10 is allowed without proceeding to heating operation (S512). This processing is determination processing which is effectively particularly after initiation of heating. When the minimum temperature is lower than the lower-limit temperature when the maximum temperature is lower than the upper-limit temperature, the control section 26 outputs a heating command to the heater 36, thereby initiating heating of the secondary battery 30 (S505). After initiation of heating operation, the control section 26 again acquires the temperatures T(1) to T(M) and voltages V1 to Vn from the storage section 28 (S506), and calculates the voltage variation ΔV and the temperature variation ΔT (S507). Specifically, ΔT is calculated as a difference between the maximum temperature Tmax and the minimum temperature Tmin among the temperatures T(1) to T(M) acquired in S506, and ΔV is calculated as a difference between the maximum voltage Vmax and the minimum voltage Vmin among the voltages V1 to Vn acquired in S506. After calculation of the voltage and temperature variations, these variations are compared with corresponding predetermined allowable values. First, a determination is made as to whether or not the voltage variation ΔV is lower than or equal to an allowable threshold value (S508). When the voltage variation ΔV is lower than or equal to the allowable threshold value, no problem exists in the voltage. Hence, a determination is made as to whether or not the temperature variation ΔT is lower than or equal to an allowable threshold value (S510). When the temperature variation ΔT is also lower than or equal to the allowable threshold value, no problem is determined to exist in the voltage and the temperature. Heating operation of the heater 36 is continued, and processing subsequent to S503 is iterated. Specifically, a determination is again made as to whether or not the temperature of the secondary battery 30 is lower than or equal to the lower-limit temperature. When the temperature is lower than the lower-limit temperature, heating is continually performed (“initiation of heating” means continuation of heating). When the temperature has become equal to or higher than the lower-limit temperature or the upper-limit temperature, heating is stopped (S511). Start-up processing of the vehicle ECU 10 is allowed (S512).

When the voltage variation ΔV exceeds an allowable threshold value or when the voltage variation ΔV is lower than or equal to the allowable threshold value but the temperature variation ΔT is in excess of the allowable threshold value, continuation of heating in the manner in which it is currently proceeding is not appropriate, and hence processing proceeds to predetermined uniforming operation (S509). After performance of uniforming operation, processing subsequent to S503 is again iterated. Specifically, a determination is made as to whether or not the temperature of the secondary battery 30 is lower than the lower-limit value. When the temperature has risen in excess of the lower-limit temperature, heating is stopped (S511), and start-up processing of the vehicle ECU 10 is allowed (S512).

What is claimed is:

1. An apparatus for controlling a temperature of a secondary battery, comprising:
a heating section for heating a secondary battery formed by combination of a plurality of battery modules;
a temperature measurement section for detecting the temperature of the secondary battery; and
a control section which causes the heating section to operate when the temperature detected by the temperature measurement section is lower than a lower-limit temperature and performs uniforming operation to suppress variations when variations in the temperature of the secondary battery achieved after heating operation of the heating section exceed an allowable value.

2. An apparatus for controlling a temperature of a secondary battery, comprising:
a heating section for heating a secondary battery formed by combination of a plurality of battery modules;
a temperature measurement section for detecting the temperature of the secondary battery;
a voltage measurement section for detecting an open circuit voltage of the secondary battery; and
a control section which causes the heating section to operate when the temperature detected by the temperature measurement section is lower than a lower-limit temperature and performs uniforming operation to suppress variations when variations in open circuit voltage of the secondary battery detected by the voltage measurement section after heating operation of the heating section exceed an allowable value.

3. An apparatus for controlling a temperature of a secondary battery, comprising:
a heating section for heating a secondary battery formed by combination of a plurality of battery modules;
a temperature measurement section for detecting the temperature of the secondary battery;
a voltage measurement section for detecting an open circuit voltage of the secondary battery; and
a control section which causes the heating section to operate when the temperature detected by the temperature measurement section is lower than a lower-limit temperature and which performs uniforming operation to suppress variations when an allowable value is exceeded by at least either variations in the temperature of the secondary battery detected by the temperature measurement section after heating operation or variations in open circuit voltage of the secondary battery detected by the voltage measurement section after heating operation of the heating section.

4. The apparatus according to claim 3, wherein the uniforming operation is processing for diminishing the amount of heat generated by the heating section.

5. The apparatus according to claim 3, wherein the uniforming operation is processing for stopping heating operation of the heating section.

6. The apparatus according to claim 3, wherein the uniforming operation is processing for driving a fan, to thus cause forced convection.

7. The apparatus according to claim 3, wherein the uniforming operation is processing for diminishing the amount of heat generated by the heating section and driving a fan to cause forced convection.

8. The apparatus according to claim 3, wherein the uniforming operation is processing for stopping heating operation of the heating section and driving a fan to cause forced convection.

9. The apparatus according to claim 3, wherein the uniforming operation is repeatedly performed within a predetermined period of time until the variation becomes equal to or less than the allowable value.

10. The apparatus according to claim 3, wherein, when at least either variations in the temperature of the secondary battery or variations in open circuit voltage of the secondary battery exceed a first allowable value, the control section performs, as the uniforming operation, processing for stopping heating operation of the heating section and processing for driving the fan to cause forced convection; and, when at least either of the variations is equal to or less than the first allowable value and exceed a second allowable value smaller than the first allowable value, the control section performs, as the uniforming operation, processing for diminishing the amount of heat generated by the heating section.

11. A battery pack for use in a vehicle comprising the temperature controlling apparatus according to claim 3.

12. The battery pack according to claim 11, wherein, when the temperature of the secondary battery is lower than the lower-limit temperature at the time of startup of a vehicle, the control section activates the heating section until the temperature becomes equal to or higher than the lower-limit temperature.

13. A computer-readable medium storing a program for causing a computer to perform processing for controlling a temperature of a secondary battery formed by combination of a plurality of battery modules, the processing comprising:
inputting a temperature of the secondary battery output from a temperature measurement section or an open circuit voltage of the secondary battery output from a voltage measurement section;
comparing a predetermined lower-limit temperature stored in memory with the temperature;
outputting a heating command to a heating section when the temperature is determined to be lower than the lower-limit temperature;
calculating variations in the temperature of the secondary battery detected by the temperature measurement section after heating operation of the heating section or variations in the open circuit voltage of the secondary battery detected by the voltage measurement section;
comparing a predetermined allowable threshold value stored in the memory with the temperature variations or the open circuit voltage variations; and
performing predetermined uniforming operation for reducing the variations when at least either the temperature variations or the open circuit voltage variations are determined to have exceeded the predetermined allowable threshold value.

14. The medium according to claim 13, wherein the uniforming operation is processing for commanding the heating section to diminish the amount of heat generated by the heating section.

15. The medium according to claim 13, wherein the uniforming operation is processing for commanding the heating section to stop heating operation of the heating section.

16. The medium according to claim 13, wherein the uniforming operation is processing for commanding driving of a fan.

17. The medium according to claim 13, wherein the program causes the computer to repeat the uniforming operation within a predetermined period of time until the variations become equal to or smaller than the allowable threshold value.
